(19) United States
(12) Patent Application Publication
(10) Pub. No.: US 2008/0177566 A1
(43) Pub. Date: Jul. 24, 2008

(54) PROVIDER DIRECTORY PUBLISHER

(75) Inventors: Murali M. Karamchedu, Beaverton, OR (US); Jeffrey B. Sponaugle, Tigard, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: KRYPTIQ CORPORATION, Hillsboro, OR (US)

(21) Appl. No.: 11/625,123

(22) Filed: Jan. 19, 2007

(51) Int. Cl. G06Q 50/00

(52) U.S. Cl. 705/2

(57) ABSTRACT

Embodiments of the present invention provide systems and methods for electronically publishing a directory of healthcare providers. Other embodiments may be described and claimed.

### TECHNICAL FIELD

Embodiments of the present invention relate to the field of data processing, and more particularly, to methods and systems for electronically publishing a directory of healthcare providers.

### BACKGROUND

There are numerous doctors and healthcare organizations that are made up of doctors that provide healthcare to individuals. Each of the doctors and healthcare organizations may provide different types of healthcare services. Doctors within healthcare organizations may themselves each provide different types of healthcare services.

As there are numerous doctors and healthcare organizations, there are also numerous types of health insurance and health coverage insurance. While health insurance generally protects against large medical or large healthcare-related bills, healthcare coverage generally provides coverage for various costs associated with overall healthcare. The coverage may include reimbursement for whole or partial costs associated with general healthcare. Employers often provide their employees with some type of health insurance or, even healthcare coverage insurance as a benefit of employment.

Because of the numerous types of doctors, healthcare organizations, insurance types and insurance providers, as well as the numerous employers providing healthcare benefits to their employees, it is difficult to obtain, organize and maintain lists or databases of various doctors and healthcare organizations, as well as related information such as, for example, areas of practice, the insurance or insurances that doctors and healthcare organizations accept, contact information, etc. It is also difficult to maintain such lists and databases since much of this information may change.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates an exemplary embodiment of a computer network that may be utilized to electronically provide, publish and access a provider directory, in accordance with various embodiments of the present invention;

FIG. 2 schematically illustrates an exemplary embodiment of a server that may be utilized to electronically provide and publish a provider directory, in accordance with various embodiments of the present invention; and

FIG. 3 is a flowchart illustrating a process for electronically providing, publishing and accessing a provider directory, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide systems and methods for publishing a directory of healthcare providers.

Various embodiments of the present invention will be described herein with respect to obtaining data, organizing the data into a database and publishing the database with respect to healthcare providers for clarity and simplicity. However, those skilled in the art will understand that the present invention may be applicable to obtaining data, organizing the data into a database and publishing the database with respect to of other areas.

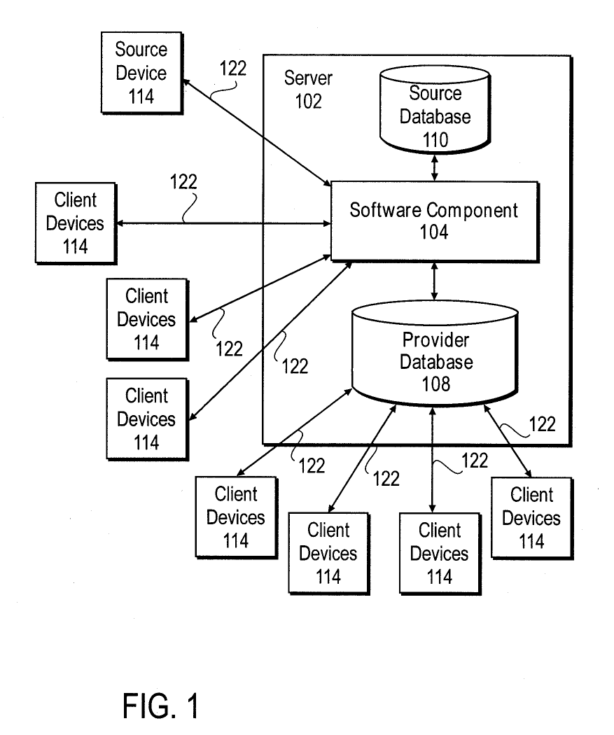

Referring now to FIG. 1, an overview of the present invention, in accordance with various embodiments, may be described. As illustrated, for the embodiments, server 102 is endowed with software component 104, which is adapted with functions to receive information from source sites, process information and provide information to client sites. In particular, as will be described in more detail below, software component 104 is adapted to receive information from source devices 112, process and organize the information for provider database 108 and provide client devices 114 with summary data relating to healthcare providers from provider database 108.

For the various embodiments, server 102 may be provided with provider database 108. In alternate embodiments, provider database 108 may be remotely disposed away from server 102.

For the various embodiments, server 102 may be provided with source database 110 having data of the sources. In alternate embodiments, source database 108 may be remotely disposed away from server 102.

In various embodiments, software component 104 presents the summary data directly on client devices 114. In particular, for the various embodiments, software component 104 presents the summary data in the form of web pages. That is, server 102 is further endowed with a web server and various communication interfaces, whereas client devices 114 are endowed with a browser and corresponding communication devices.

In other embodiments, the summary data may be presented in other formats, e.g. as an attachment to electronic communications, as printed mailings, and so forth.

For the various embodiments, source devices 112 and client devices 114 are communicatively coupled to server 102 via network connections 122 over a number of private and/or public networks, including, but not limited to, the Internet. The communications between source devices 112, client devices 114 and server 102 may be conducted in accordance with one of a number of messaging protocols, including but are not limited to, e.g., the HTTP protocol (HTTP=Hypertext Transmission Protocol).

Except for software component 104, databases 108, 110, server 102, source devices 112 and client devices 114 represent a broad range of such elements known in the art, or to be designed (as long as they are consistent with the teachings of the present invention). Accordingly, except for software component 104, and an example of server 102, databases 108, 110, source devices 112, client devices 114 and coupling 122 will not be further described.

While for ease of understanding, server 102 is “singularly” illustrated, in various embodiments, server 102 may be a single computing device, a cluster of tightly coupled computing devices, or networked computing devices.

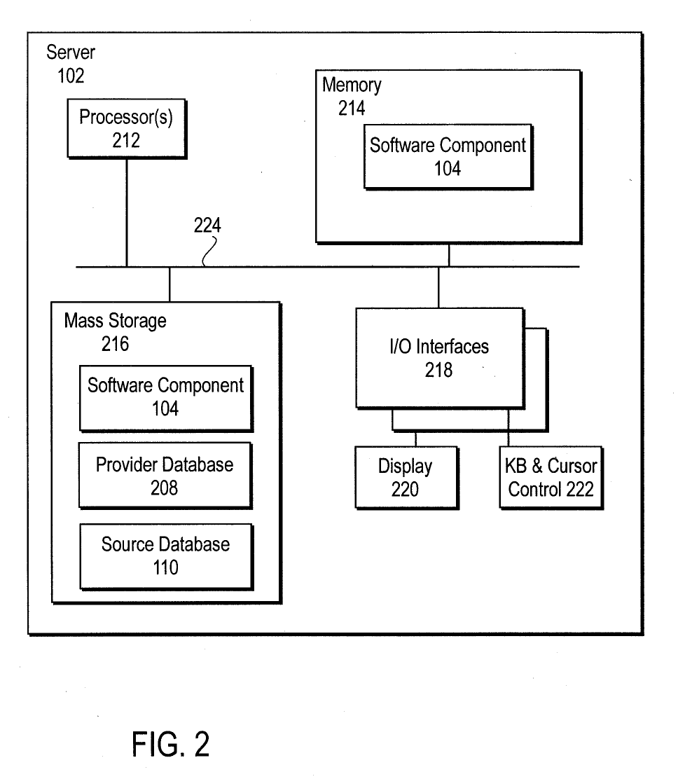

FIG. 2 illustrates an example implementation of server 102 of FIG. 1, in accordance with various embodiments of the present invention. As illustrated, server 102 includes digital computing processor 212, memory 214 coupled to each other via bus 224. Further, device 212 includes mass storage device 216, I/O interfaces 218, and a number of I/O devices coupled to each other and the earlier described elements as shown. Memory 214 and mass storage device 216 include in particular, a transient and a persistent copy of software component 104, respectively. Mass storage device 216 further includes databases 108, 110. The I/O devices include in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp., of Santa Clara, Calif.

Memory 214 may likewise be any one of a number of volatile storage known in the art or to be designed (as long as they are consistent with the teachings of the present invention), including but are not limited to, the volatile storage available from Kingston Technology of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of Scotts Valley, Calif.

In various embodiments, I/O interfaces 218 include a communication interface for coupling server 102 to source devices 112 and client devices 114. The communication interface may be a wire based or wireless interface, coupling server 102 to devices 112, 114 via a wired/wireless local/wide area network. An example of a suitable wired network interface includes but is not limited to an Ethernet interface, and an example of a suitable wireless network interface includes, but is not limited to, an IEEE 802.11b (working group) network interface.

Except for software component 104 (described further herein), and the manner these elements are employed, each of these elements represents a broad range of the corresponding element known in the art or to be designed, consistent with the teachings of the present invention. The elements perform their conventional functions, i.e. processing, storage, reading, displaying, and so forth. While for ease of understanding, software component 104 is “singularly” illustrated, in various embodiments, software component 104 may be a single or a plurality of processes, executed as a single thread or multiple threads, on a single or multiple processors.

In accordance with various embodiments of the present invention, source devices 112 provide information relating to various healthcare providers and/or healthcare networks/organizations to server 102. Examples of entities that may have source devices include, but are not limited to, healthcare providers, employers, marketing organizations and various types of service providers. The information received from the source devices 112 include, but is not limited to, an area of practice or areas of practice for healthcare providers, accepted insurance carriers, medical network or medical organization affiliations, biographical information and contact information. Examples of contact information include, but are not limited to, an address, electronic mail address (e-mail), a facsimile number, and a telephone number.

Server 102 processes and organizes the information when it is received in order to provide a healthcare provider database 108. Thus, healthcare providers and/or healthcare networks/organizations may be accessed within the healthcare provider database 108 in various manners. For example, providers may be accessed alphabetically, based upon areas of practice, based upon insurance carriers accepted, healthcare network/organization affiliation, location, etc. Additionally, the healthcare provider database may organize healthcare provider networks/organizations or networks in a similar fashion. Thus, healthcare organizations and networks may be accessed within the database 108 as described above with regard to healthcare providers.

In accordance with various embodiments of the present invention, as information is received from source devices, server 102 may verify received information with another source device, eliminating duplicates and correcting the information, if appropriate. This helps provide an accurate database, as well as eliminating duplicate entries for healthcare providers and organizations.

When a client device 114 wishes to obtain information regarding healthcare providers and/or healthcare provider networks/organizations, the client device accesses healthcare provider database 108 via a network. The client device may search the healthcare provider database based upon the various parameters discussed above in order to obtain a list of healthcare providers that may suit their desires or needs. Additionally, a client device may search the healthcare provider database for information relating to a specific healthcare provider and/or healthcare provider network/organization. Examples of entities that may have client devices include, but are not limited to, employees, employers, service providers, insurance carriers, medical networks or organizations, and members of the general public.

Access to healthcare provider database 108 is generally provided over a network, as noted above, such as, for example, the Internet. One or more graphic user interfaces are provided at the healthcare provider database in order to allow for access, searching, and retrieval of information relating to healthcare providers.

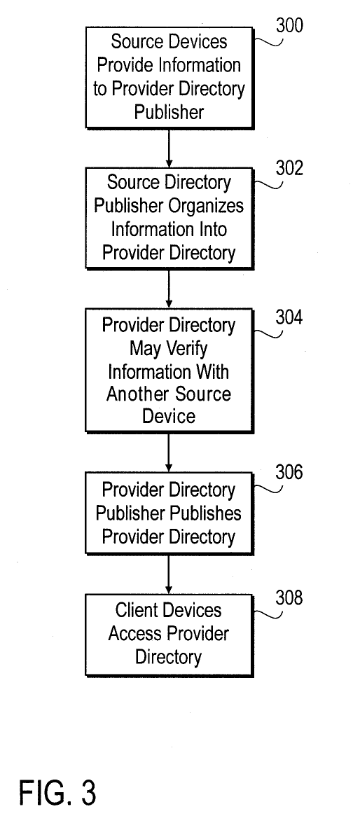

Thus, with reference to FIG. 3, in accordance with various embodiments of the present invention, source devices provide information to a provider directory publisher at block 300. At block 302, the provider directory publisher organizes the information within a database into a provider directory, in accordance with various embodiments of the present invention. In accordance with various embodiments of the present invention, the provider directory publisher may verify information provided by a source device with another source device, including eliminating duplicates and correcting information where appropriate, at block 304. The provider directory publisher publishes, at block 306, the provider directory at a network address that may be accessed by client devices over a network, such as, for example, the Internet, in accordance with various embodiments of the present invention. Client devices may then access and search the provider directory through the network via one or more graphical user interfaces at block 308, in accordance with various embodiments of the present invention.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. (canceled)

2. A method of electronically publishing a healthcare provider database, the method comprising:
receiving, at a provider publisher server, information from a plurality of sources relating to healthcare providers;
automatically organizing, by the provider publisher server via a software component, the information into the healthcare provider database; and
automatically publishing the healthcare provider database via the software component at a network address controlled by the provider publisher server;
wherein receiving the information comprises receiving the information from a plurality of sources that comprise healthcare providers, employers, marketing organizations and service providers.

3. The method of claim 2, wherein organizing the information comprises listing healthcare providers based upon at least one of a group of parameters comprising area of practice, accepted insurance carriers, medical network affiliation, biographical information and contact information.

4. The method of claim 3, wherein contact information comprises at least one of an address, an electronic mail address, a telephone number and a facsimile number.

5. The method of claim 2, further comprising verifying, by the provider publisher server, information received from a source with another source.

6. The method of claim 2, wherein publishing the healthcare provider database comprises providing at least one graphical user interface for use by a user accessing the healthcare provider database published at the network address.

7. (canceled)

8. A system for electronically publishing a healthcare provider database, the system comprising:
one or more storage devices including one more databases adapted to store data; and
one or more servers operatively coupled to the one or more storage devices, the one or more servers being configured to receive and automatically organize data for the healthcare provider database from a plurality of sources, the one or more servers being further configured to automatically publish the healthcare provider database at a network address controlled by the one or more servers;
wherein the plurality of sources may be from a group comprising healthcare providers, employers, marketing organizations and service providers.

9. The system of claim 8, wherein the one or more servers are configured to organize the data based upon at least one of a group of parameters comprising area of practice, accepted insurance carriers, medical network affiliation, biographical information and contact information.

10. The system of claim 9, wherein contact information comprises at least one of an address, an electronic mail address, a telephone address and a facsimile number.

11. The system of claim 8, further comprising at least one graphical user interface provided at the one or more servers to allow access by users.

12. The system of claim 8, wherein the one or more servers is configured to verify information received from one source with another source.

13. (canceled)

14. An article of manufacture comprising:
a storage medium; and
a plurality of instructions stored therein;
wherein the plurality of instructions are adapted to cause one or more processors to perform a plurality of provider publisher operations, the plurality of operations comprising:
receiving information from a plurality of sources relating to healthcare providers;
automatically organizing the information into the healthcare provider database; and
automatically publishing the healthcare provider database at a network address controlled by the provider publisher;
wherein receiving the information comprises receiving the information from a plurality of sources that comprise healthcare providers, employers, marketing organizations and service providers.

15. The article of manufacture of claim 14, wherein organizing the information comprises listing healthcare providers based upon at least one of a group of parameters comprising area of practice, accepted insurance carriers, medical network affiliation, biographical information and contact information.

16. The article of manufacture of claim 15, wherein contact information comprises at least one of an address, an electronic mail address, a telephone number and a facsimile number.

17. The article of manufacture of claim 14, wherein the plurality of instructions further comprise verifying information received from a source with another source.

18. The article of manufacture of claim 14, wherein publishing the healthcare provider database comprises providing at least one graphical user interface for use by a user accessing the network address.
